(19) United States
(12) Patent Application Publication
(10) Pub. No.: US 2024/0346625 A1
(43) Pub. Date: Oct. 17, 2024

(54) THERMAL IMAGE SHADING REDUCTION SYSTEMS AND METHODS

(71) Applicant: Teledyne FLIR Commercial Systems, Inc., Goleta, CA (US)

(72) Inventors: Umesh Rao, Santa Barbara, CA (US); Stephanie Lin, Buellton, CA (US)

(21) Appl. No.: 18/752,655

(22) Filed: Jun. 24, 2024

Related U.S. Application Data
(63) Continuation of application No. PCT/US2022/054098, filed on Dec. 27, 2022.

(51) Int. Cl. G06T 5/50; G06T 3/40

(52) U.S. Cl. CPC G06T 5/50; G06T 3/40; G06T 2207/10048; G06T 2207/20224

(57) ABSTRACT

Various techniques are provided to reduce shading in thermal images. In one example, a method includes receiving a captured thermal image having an original resolution, wherein the captured thermal image comprises scene information and shading information. The method includes processing the captured thermal image to generate a plurality of downscaled images each having an associated reduced resolution lower than the original resolution and different from each other, wherein the downscaled images exhibit reduced scene information in relation to the captured thermal image. The method includes generating a shading image using the downscaled images. The method includes adjusting the captured thermal image using the shading image to generate a processed thermal image with reduced shading information in relation to the captured thermal image. Additional methods and systems are also provided.

### CROSS REFERENCE TO RELATED APPLICATIONS

This application is a continuation of International Patent Application No. PCT/US2022/054098 filed Dec. 27, 2022 and entitled “THERMAL IMAGE SHADING REDUCTION SYSTEMS AND METHODS,” which claims priority to and the benefit of U.S. Provisional Patent Application No. 63/295,434 filed Dec. 30, 2021 and entitled “THERMAL IMAGE SHADING REDUCTION SYSTEMS AND METHODS,” all of which are incorporated herein by reference in their entirety.

### TECHNICAL FIELD

The present invention relates generally to thermal imaging and, more particularly, to removing shading from thermal images.

### BACKGROUND

Thermal imaging systems are used in a variety of applications to capture images of thermal wavelengths. For example, thermal imaging systems may be implemented as thermal cameras for use with vehicles such as cars, trucks, aerial vehicles, watercraft, and others.

However, captured thermal images may exhibit shading that hides details associated with objects of interest. For example, shading may appear in thermal images as additional thermal gradients that partially or entirely obscure objects of interest.

Shading may be caused by extreme temperatures, rain, snow, moisture, and/or other conditions. Shading may also be caused by various heat sources, such as heat emitting objects. Unfortunately, conventional approaches to shading removal are often computationally intensive and may not be readily implemented in thermal imaging systems, particularly in portable systems that may have limited processing resources.

### SUMMARY

Various techniques are disclosed to reduce shading in thermal images and thereby provide more shades of gray back to objects of interest of in a scene. As a result, contrast can be increased. Additional techniques are provided to compress pixel values in a first range that are greater than or equal to an intermediate pixel value and expand pixel values in a second range that are less than the intermediate pixel value to derive a smooth form of the thermal image.

In one embodiment, a method includes receiving a captured thermal image having an original resolution, wherein the captured thermal image comprises scene information and shading information; processing the captured thermal image to generate a plurality of downscaled images each having an associated reduced resolution lower than the original resolution and different from each other, wherein the downscaled images exhibit reduced scene information in relation to the captured thermal image; generating a shading image using the downscaled images; and adjusting the captured thermal image using the shading image to generate a processed thermal image with reduced shading information in relation to the captured thermal image.

In another embodiment, a system includes a memory component storing machine-executable instructions; and a logic device configured to execute the instructions to cause the system to: receive a captured thermal image having an original resolution, wherein the captured thermal image comprises scene information and shading information, process the captured thermal image to generate a plurality of downscaled images each having an associated reduced resolution lower than the original resolution and different from each other, wherein the downscaled images exhibit reduced scene information in relation to the captured thermal image; generate a shading image using the downscaled images, and adjust the captured thermal image using the shading image to generate a processed thermal image with reduced shading information in relation to the captured thermal image.

The scope of the present disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an imaging system in accordance with an embodiment of the disclosure.

FIG. 2 illustrates a flow diagram of a process to reduce shading in a thermal image in accordance with an embodiment of the disclosure.

FIGS. 3A-3H illustrate the various changes to the original thermal image through the process described in FIG. 2 in accordance with embodiments of the disclosure.

FIGS. 4A-4H illustrate another example of the various changes to the original thermal image through the process described in FIG. 2 in accordance with embodiments of the disclosure.

Embodiments of the present disclosure and their advantages are best understood by referring to the detailed description that follows. It is noted that sizes of various components and distances between these components are not drawn to scale in the figures. It should be appreciated that like reference numerals are used to identify like elements illustrated in one or more of the figures.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology.

In one or more embodiments, various systems and methods are provided. In some aspects, such systems and methods may be used for thermal imaging, such as thermal imaging. Such thermal imaging may be used for various applications, such as safety and vehicular (e.g., automotive) applications.

Conventional thermal imaging systems have drawbacks, such as identifying unwanted heat sources that obstruct the detail associated with an object of interest. In order to provide a thermal imaging system that addresses these issues, embodiments of the present invention accurately calculate and correct shading in a thermal image so that the detail of an object of interest is clearly identified. That is, shading reduction in thermal imagery takes out shades of gray from other more important portions of the scene. Most of this sort of shading, such as out of field irradiance from a window heater or the cooling of propellers from a drone, offer very little information for a user. Thus, various embodiments of the present invention reduce shading in a thermal imagery and thereby offers more shades of gray back to object(s) of interest of the scene content, bringing out more contrast in the portions of a scene that matter. Additionally, various embodiments of the present invention perform tone optimization (e.g., pixel value adjustment). The tone optimization adjusts down pixel values in a first range that are greater than or equal to an intermediate pixel value and adjust up pixel values in a second range that are less than the intermediate pixel value. The tone optimization is a simple and quick way to derive a smooth form of the thermal image.

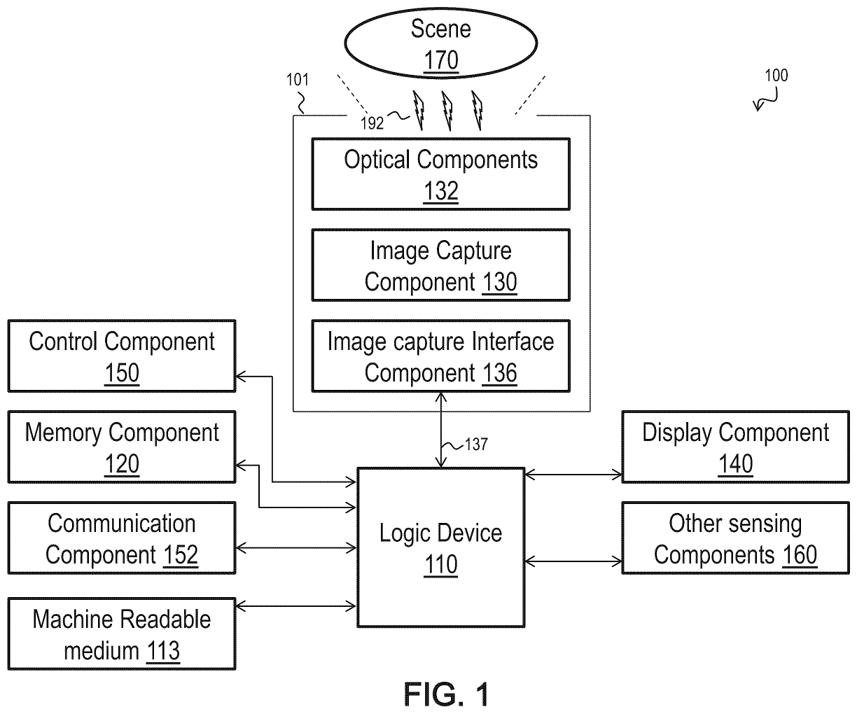

Turning now to the drawings, FIG. 1 illustrates a block diagram of an imaging system 100 in accordance with an embodiment of the disclosure. Imaging system 100 may be used to capture and process images (e.g., image frames) in accordance with techniques described herein. In some embodiments, various components of imaging system 100 may be provided in a camera component 101, such as an imaging camera. In other embodiments, one or more components of imaging system 100 may be implemented remotely from each other in a distributed fashion (e.g., networked or otherwise).

In some embodiments, imaging system 100 may be used to detect one or more objects of interest within a scene 170. For example, imaging system 100 may be configured to capture and process thermal images (e.g., thermal image frames) of scene 170 in response to thermal radiation (e.g., thermal radiation 192) received therefrom. Thermal radiation 192 may correspond to wavelengths that are emitted and/or absorbed by an object of interest within scene 170.

Captured images may be received by a logic device 110 and stored in a memory component 120. Logic device 110 may be configured to process the captured images in accordance with thermal detection techniques discussed herein.

In some embodiments, imaging system 100 includes logic device 110, a machine readable medium 113, a memory component 120, image capture component 130, optical components 132, an image capture interface component 136, a display component 140, a control component 150, a communication component 152, and other sensing components 160.

In some embodiments, imaging system 100 may be implemented as an imaging camera, such as camera component 101, to capture images, for example, of scene 170 (e.g., a field of view). In some embodiments, camera component 101 may include image capture component 130, optical components 132, and image capture interface component 136 housed in a protective enclosure. Imaging system 100 may represent any type of camera system which, for example, detects electromagnetic radiation (e.g., thermal radiation 192 received from scene 170) and provides representative data (e.g., one or more still images or video images). For example, imaging system 100 may represent a camera component 101 that is directed to detect thermal radiation and/or visible light and provide associated image data.

In some embodiments, imaging system 100 may include a portable device and may be implemented, for example, coupled to various types of vehicles (e.g., an automobile, a truck, or other land-based vehicles). Imaging system 100 may be implemented with camera component 101 at various types of fixed scenes (e.g., automobile roadway, train railway, or other scenes) via one or more types of structural mounts. In some embodiments, camera component 101 may be mounted in a stationary arrangement to capture repetitive thermal images of scene 170.

In some embodiments, logic device 110 may include, for example, a microprocessor, a single-core processor, a multi-core processor, a microcontroller, a programmable logic device configured to perform processing operations, a digital signal processing (DSP) device, one or more memories for storing executable instructions (e.g., software, firmware, or other instructions), and/or any other appropriate combinations of processing device and/or memory to execute instructions to perform any of the various operations described herein. Logic device 110 is configured to interface and communicate with the various components illustrated in FIG. 1 to perform method and processing steps as described herein. In various embodiments, it should be appreciated that processing operations and/or instructions may be integrated in software and/or hardware as part of logic device 110, or code (e.g., software or configuration data) which may be stored in memory component 120. Embodiments of processing operations and/or instructions disclosed herein may be stored by machine readable medium 113 in a non-transitory manner (e.g., a memory, a hard drive, a compact disk, a digital video disk, or a flash memory) to be executed by a computer (e.g., logic or processor-based system) to perform various methods disclosed herein.

In various embodiments, the machine readable medium 113 may be included as part of imaging system 100 and/or separate from imaging system 100, with stored instructions provided to imaging system 100 by coupling the machine readable medium 113 to imaging system 100 and/or by imaging system 100 downloading (e.g., via a wired or wireless link) the instructions from the machine readable medium (e.g., containing the non-transitory information). In various embodiments, as described herein, instructions provide for real time applications of processing various images of scene 170.

In some embodiments, memory component 120 may include one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, or other types of memory. In one embodiment, logic device 110 is configured to execute software stored in memory component 120 and/or machine readable medium 113 to perform various methods, processes, and operations in a manner as described herein.

In some embodiments, image capture component 130 may include an array of sensors (e.g., any type visible light, thermal, or other type of detector) for capturing images of scene 170. In one embodiment, the sensors of image capture component 130 provide for representing (e.g., converting) a captured images of scene 170 as digital data (e.g., via an analog-to-digital converter included as part of the sensor or separate from the sensor as part of imaging system 100). As further discussed herein, image capture component 130 may be implemented as an array of thermal sensors having at least two different types of filters distributed among the various sensors of the array.

In some embodiments, logic device 110 may be configured to receive images from image capture component 130, process the images, store the original and/or processed images in memory component 120, and/or retrieve stored images from memory component 120. In various aspects, logic device 110 may be remotely positioned, and logic device 110 may be configured to remotely receive images from image capture component 130 via wired or wireless communication with image capture interface component 136, as described herein. Logic device 110 may be configured to process images stored in memory component 120 to provide images (e.g., captured and/or processed images) to display component 140 for viewing by a user.

In some embodiments, display component 140 may include an image display device (e.g., a liquid crystal display (LCD)) or various other types of generally known video displays or monitors. Logic device 110 may be configured to display image data and information on display component 140. Logic device 110 may be configured to retrieve image data and information from memory component 120 and display any retrieved image data and information on display component 140. Display component 140 may include display electronics, which may be utilized by logic device 110 to display image data and information. Display component 140 may receive image data and information directly from image capture component 130 via logic device 110, or the image data and information may be transferred from memory component 120 via logic device 110.

In some embodiments, control component 150 may include a user input and/or interface device having one or more user actuated components, such as one or more push buttons, slide bars, rotatable knobs or a keyboard, that are configured to generate one or more user actuated input control signals. Control component 150 may be configured to be integrated as part of display component 140 to operate as both a user input device and a display device, such as, for example, a touch screen device configured to receive input signals from a user touching different parts of the display screen. Logic device 110 may be configured to sense control input signals from control component 150 and respond to any sensed control input signals received therefrom.

In some embodiments, control component 150 may include a control panel unit (e.g., a wired or wireless handheld control unit) having one or more user-activated mechanisms (e.g., buttons, knobs, sliders, or others) configured to interface with a user and receive user input control signals. In various embodiments, it should be appreciated that the control panel unit may be configured to include one or more other user-activated mechanisms to provide various other control operations of imaging system 100, such as auto-focus, menu enable and selection, field of view (FoV), brightness, contrast, gain, offset, spatial, temporal, and/or various other features and/or parameters.

In some embodiments, control component 150 may include a graphical user interface (GUI), which may be integrated as part of display component 140 (e.g., a user actuated touch screen), having one or more images of the user-activated mechanisms (e.g., buttons, knobs, sliders, or others), which are configured to interface with a user and receive user input control signals via the display component 140. As an example for one or more embodiments as discussed further herein, display component 140 and control component 150 may represent appropriate portions of a tablet, a laptop computer, a desktop computer, or other type of device.

In some embodiments, logic device 110 may be configured to communicate with image capture interface component 136 (e.g., by receiving data and information from image capture component 130). Image capture interface component 136 may be configured to receive images from image capture component 130 and communicate the images to logic device 110 directly or through one or more wired or wireless communication components (e.g., represented by connection 137) in the manner of communication component 152 further described herein. Camera component 101 and logic device 110 may be positioned proximate to or remote from each other in various embodiments.

In some embodiments, imaging system 100 may include one or more other types of sensing components 160, including environmental and/or operational sensors, depending on the sensed application or implementation, which provide information to logic device 110 (e.g., by receiving sensor information from each sensing component 160). In various embodiments, other sensing components 160 may be configured to provide data and information related to environmental conditions, such as internal and/or external temperature conditions, lighting conditions (e.g., day, night, dusk, and/or dawn), humidity levels, specific weather conditions (e.g., sun, rain, and/or snow), distance (e.g., laser rangefinder), rotation (e.g., a gyroscope), and/or whether a tunnel, a covered parking garage, or that some type of enclosure has been entered or exited. Accordingly, other sensing components 160 may include one or more conventional sensors as would be known by those skilled in the art for monitoring various conditions (e.g., environmental conditions) that may have an effect (e.g., on the image appearance) on the data provided by image capture component 130.

In some embodiments, other sensing components 160 may include devices that relay information to logic device 110 via wireless communication. For example, each sensing component 160 may be configured to receive information from a satellite, through a local broadcast (e.g., radio frequency) transmission, through a mobile or cellular network and/or through information beacons in an infrastructure (e.g., a transportation or highway information beacon infrastructure) or various other wired or wireless techniques.

In some embodiments, communication component 152 may be implemented as a network interface component (NIC) configured for communication with a network including other devices in the network. In various embodiments, communication component 152 may include one or more wired or wireless communication components, such as an Ethernet connection, a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or thermal frequency (IRF) components configured for communication with a network. As such, communication component 152 may include an antenna coupled thereto for wireless communication purposes. In other embodiments, the communication component 152 may be configured to interface with a DSL (e.g., Digital Subscriber Line) modem, a PSTN (Public Switched Telephone Network) modem, an Ethernet device, and/or various other types of wired and/or wireless network communication devices configured for communication with a network.

In some embodiments, a network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) configured to communicate with other communication networks, such as the Internet. As such, in various embodiments, imaging system 100 and/or its individual associated components may be associated with a particular network link such as for example a URL (Uniform Resource Locator), an IP (Internet Protocol) address, and/or a mobile phone number.

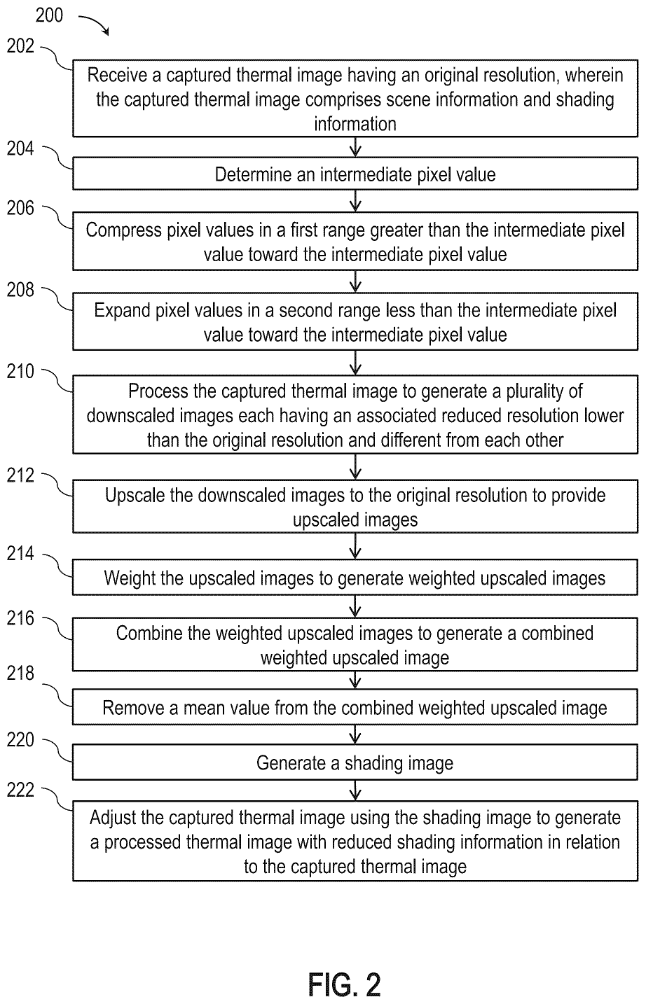

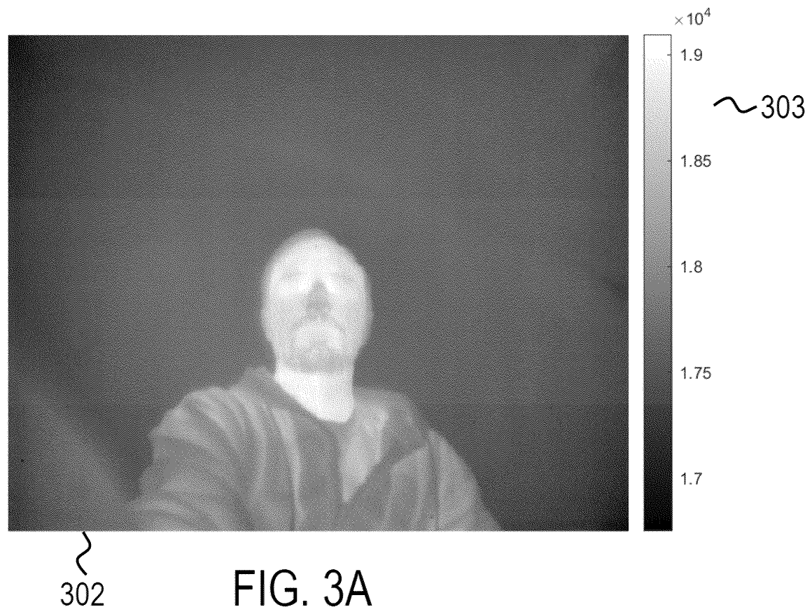

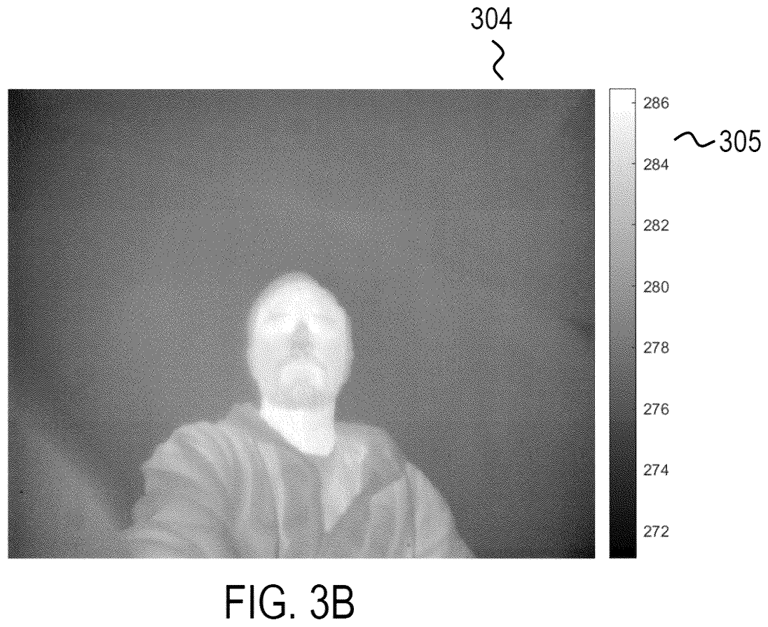

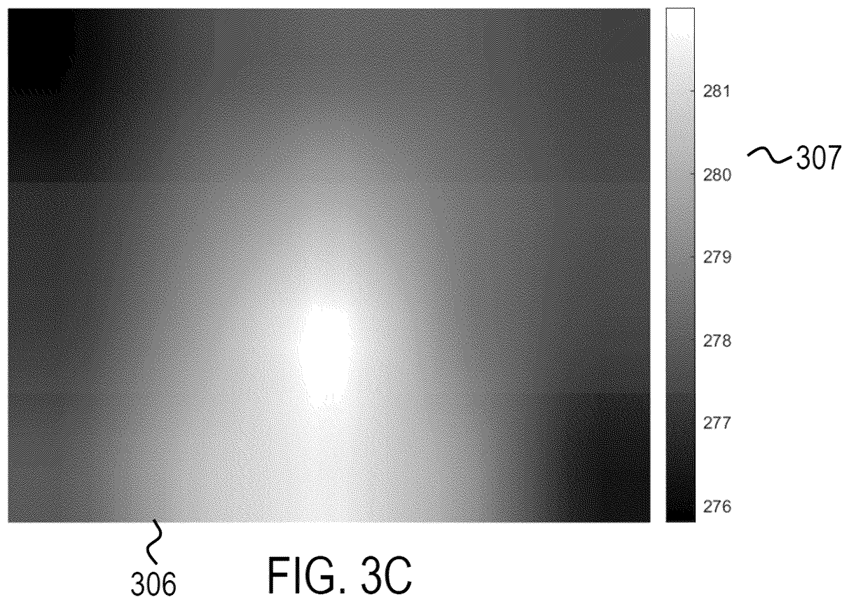

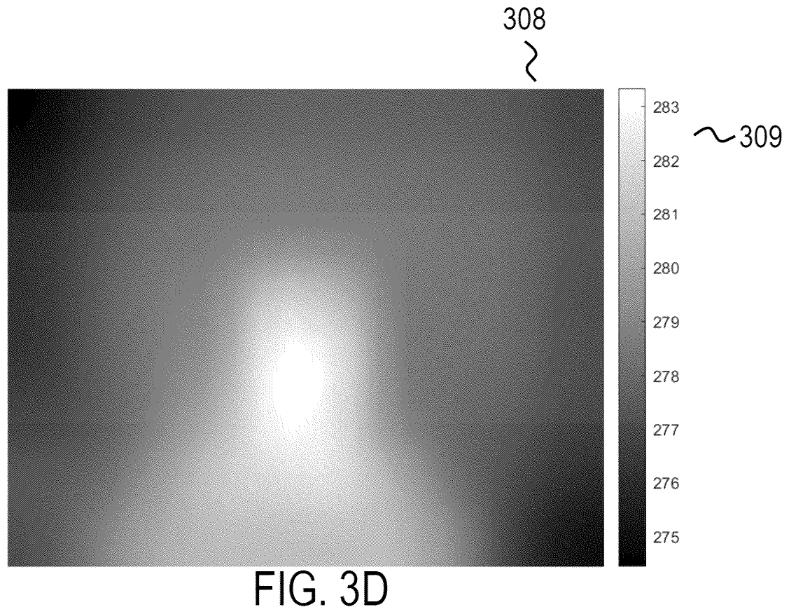

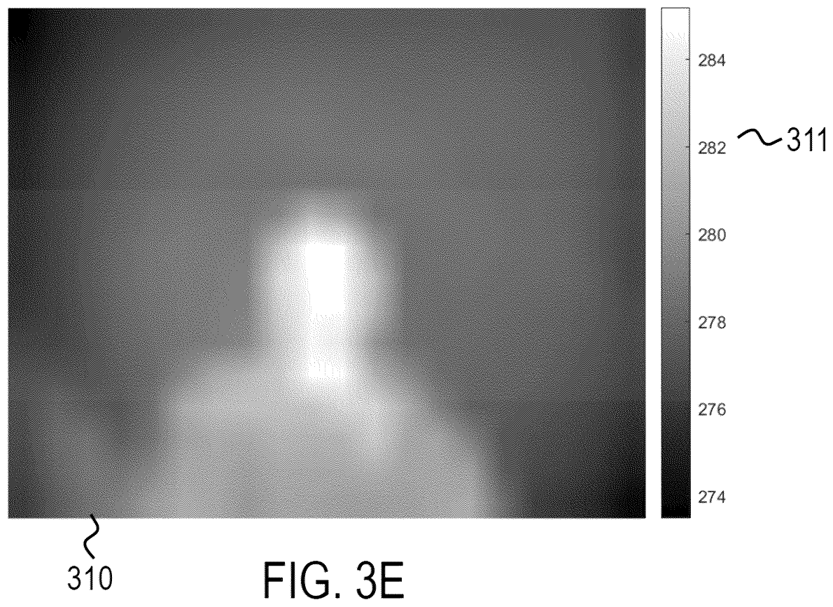

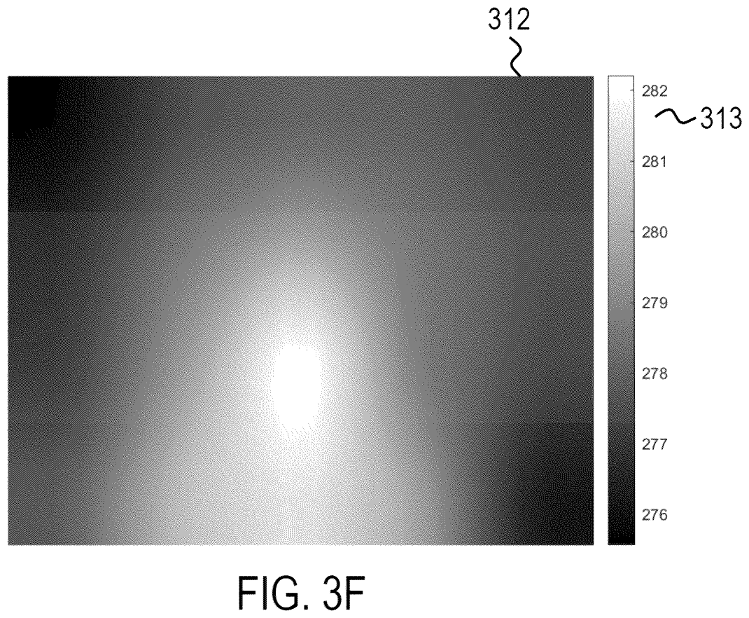

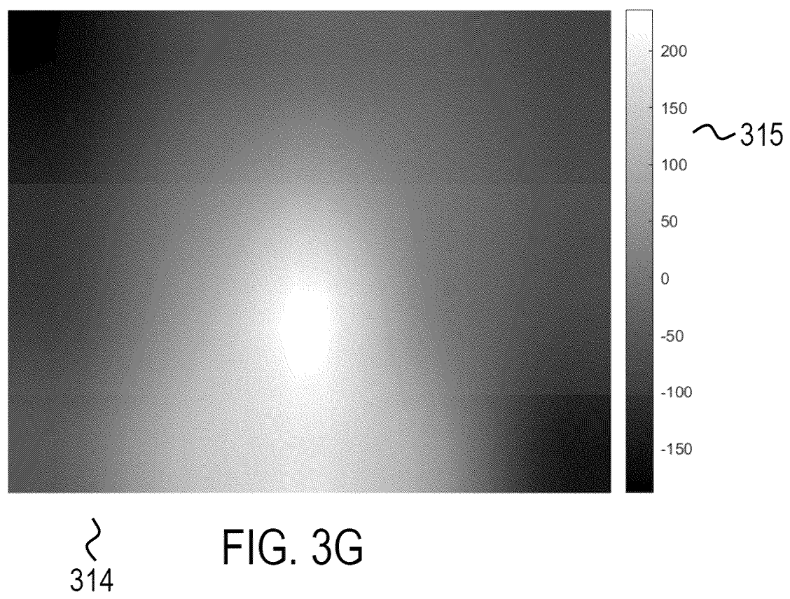

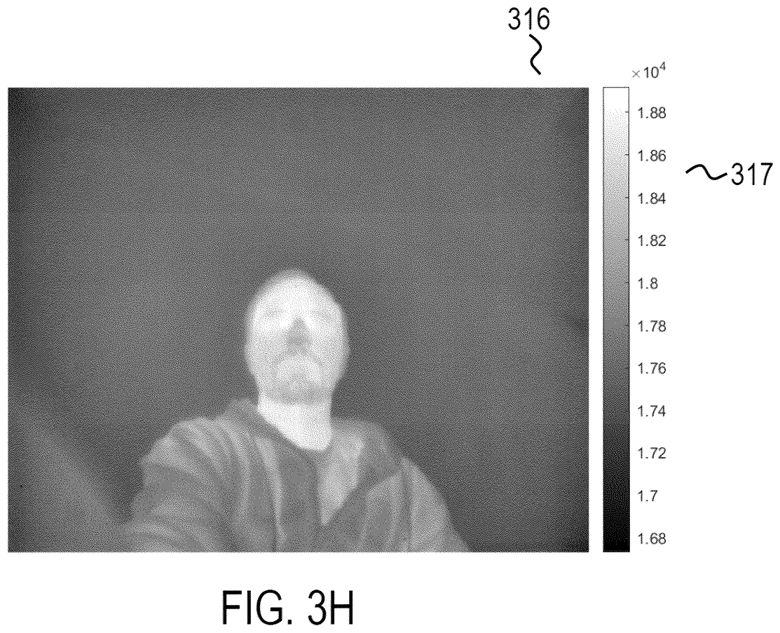

FIG. 2 illustrates a flow diagram of a process 200 to reduce shading in a thermal image thereby offering more shades of gray back to other portions of the scene content, bring out more contrast to an object of interest in the scene in accordance with an embodiment of the disclosure. The shade reduction system that performs process 200 operates on an original resolution image, such as, for example, a 512 pixels by 640 pixels 14-bit image. Thus, in block 202, logic device 110 receives a captured thermal image having an original resolution, wherein the captured thermal image comprises scene information and shading information. In one embodiment, the captured thermal image comprises a plurality of pixels having associated pixel values distributed over an original dynamic range. FIG. 3A illustrates one example of thermal image 302 at an original resolution, the original pixel resolution varying between 1.92×10⁴ to 1.66×10⁴ as shown in scale 303. At block 204, logic device 110 determines an intermediate one of the pixel values, i.e. a midtone pixel value. The intermediate pixel value is a pixel value between the mean pixel value (i.e., an average of all the pixel values in the original resolution image) and a maximum (max) pixel value (i.e., a maximum pixel value of all the pixel values in the original resolution image). Logic device 110 determines the intermediate pixel value (the midtone pixel value) using Equation 1.

$$midtone = \frac{image mean + ( maxmult - 1 ) * image max}{max mult} \qquad ( 1 )$$

In one embodiment, maxmult is a parameter used to choose the position between the mean pixel value (image mean) and the max pixel value (image max) of the original resolution image. A typical value for maxmult is, for example, 16.

Once the intermediate pixel value is determined, at block 206, logic device 110 adjusts down pixel values in the original resolution image by compressing pixel values in a first range that are greater than or equal to the intermediate pixel value toward the intermediate pixel value. Logic device 110 compresses (adjusts down) the pixel values in a first range that are greater than or equal to the intermediate pixel value (midtone pixel value) using Equation 2.

$$zt ( input \geq midtone ) = \frac{zt ( input \geq midtone ) + ( compressfac - 1 ) * midtone}{compressfac} \qquad ( 2 )$$

where zt is the input pixel value that is greater than or equal to the intermediate pixel value and the compressfac is the factor used to compress pixel values, for example, 16.

At block 208, logic device 110 adjusts up pixel values in the original resolution image by expanding (e.g., stretching) pixel values in a second range that are less than the intermediate pixel value toward the intermediate pixel value. Logic device 110 expands (adjusts up) the pixel values in a second range that are less than the intermediate pixel value (midtone pixel value) using Equation 3.

$$zt ( input < midtone ) = \frac{zt ( input < midtone ) + ( stretchfac - 1 ) * midtone}{stretchfac} \qquad ( 3 )$$

where zt is the input pixel value that is less than the intermediate pixel value and the stretchfac is the expansion factor used to expand pixel values, for example, 8. FIG. 3B illustrates one example of original resolution image 304 with both pixel values in a first range that are greater than or equal to the intermediate pixel value adjusted down (compressed) and pixel values in a second range that are less than the intermediate pixel value adjusted up (expanded). As can be seen in FIG. 3B, the toned range is a combined dynamic range of the compressed pixel values and the expanded pixel values that varies between 271 and 286 as shown in scale 305.

At block 210, logic device 110 processes the captured thermal image to generate a plurality of downscaled images each having an associated reduced resolution lower than the original resolution and different from each other. In one embodiment, each of the downscaled images in the plurality of downscaled images exhibits reduced scene information in relation to the captured thermal image. For example, with the original resolution image being at, for example, a 512 pixels by 640 pixels resolution, logic device 110 downscales the original resolution image to a plurality of downscaled images each at a different second resolution that are a multiple of the original resolution image, for example, to 4 pixels by 5 pixels, 8 pixels by 10 pixels, 16 pixels by 20 pixels. Logic device 110 downscales the original resolution image utilizing a resize function, such as bicubic, bilinear interpolation, etc., and Equations 4, 5, and 6, which correspond to zi4 for the 4 pixels by 5 pixels resolution, zi8 for the 8 pixels by 10 pixels resolution, and zi for the 16 pixels by 20 pixels resolution.)

$$zi 4 = resize ( input , [ 4 \times 5 ] ) \qquad ( 4 )$$

$$zi 8 = resize ( input , [ 8 \times 10 ] ) \qquad ( 5 )$$

$$zi = resize ( input , [ 16 \times 20 ] ) \qquad ( 6 )$$

FIG. 3C illustrates one example of a downscaled 4 pixels by 5 pixels image 306 with a resolution pixel value varying from 276 to 282 as shown in scale 307, FIG. 3D illustrates one example of a downscaled 8 pixels by 10 pixels image 308 with a resolution pixel value varying from 275 to 283 as shown in scale 309, and FIG. 3E illustrates one example of a downscaled 16 pixels by 20 pixels image 310 with a resolution pixel value varying from 274 to 285 as shown in scale 311. Therefore, the reduced dynamic range causes the downscaled images to exhibit increased shading information.

At block 212, logic device 110 upscales the downscaled images to the original resolution to provide upscaled images. That is, logic device 110 forms a plurality of upscaled images utilizing a resize function and the plurality of downscaled images. Equations 7, 8, and 9, are the upscaling equations corresponding to zi4u for the 4 pixels by 5 pixels resolution, zi8u for the 8 pixels by 10 pixels resolution, and zi for the 16 pixels by 20 pixels resolution.

$$zi 4 u = resize ( zi 4 , [ 512 \times 640 ] ) \qquad ( 7 )$$

$$zi 8 u = resize ( zi 8 , [ 512 \times 640 ] ) \qquad ( 8 )$$

$$ziu = resize ( zi , [ 512 \times 640 ] ) \qquad ( 9 )$$

In order to generate a shading image using the upscaled images, which are based on the downscaled images, logic device 110 utilizes the upscaled images zi4u, zi8u, and ziu, to determine a shading value based on a weighted sum of different levels of upscaling of the plurality of upscaled image. To determine the shading value, at block 214, logic device 110 weights the upscaled images to generate weighted upscaled images and, at block 216, logic device 110 combines the weighted upscaled images to generate a combined (cumulative) weighted upscaled image utilizing Equation 10.

$$zicumulative = ( P 4 * zi 4 u + P 8 * zi 8 u + P * ziu ) / ( P 4 + P 8 + P ) \qquad ( 10 )$$

where P4, P8, and P are constants. FIG. 3F illustrates one example of a weighted sum image 312 with a resolution pixel value varying from 276 to 282 as shown in scale 313. Then, at block 218, logic device 110 removes a mean value from the combined (cumulative) weighted upscaled image to determine the shading value using Equation 11.

$$shading = zicumulative - mean ( zicumulative ) \qquad ( 11 )$$

Thus, at block 220, logic device 110 utilizes the shading value to generate a shading image. FIG. 3G illustrates one example of a shading image 314 with a resolution pixel value varying from −180 to 230 as shown in scale 315. At block 222, logic device 110 adjusts the captured thermal image using the shading image to generate a processed thermal image with reduced shading information in relation to the captured thermal image. In one embodiment, to adjust the captured thermal image using the shading image, logic device 110 subtracts the shading value from the original resolution image to generate the processed thermal image. FIG. 3H illustrates one example of a shading corrected image 316. As can be seen in FIG. 3H the resolution pixel value has changed to vary between 1.68×10⁴ and 1.89×10⁴ as shown in scale 317. Thus, the processed thermal image exhibits further reduced shading information

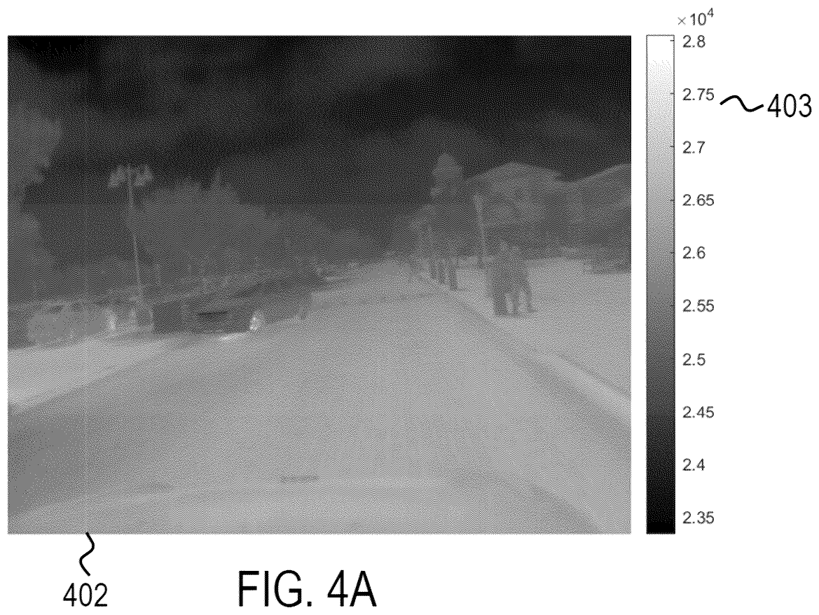

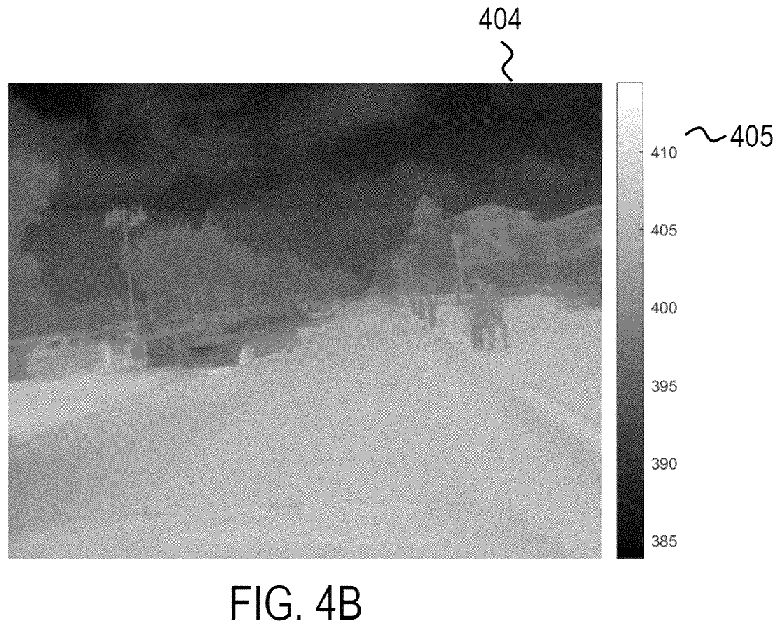

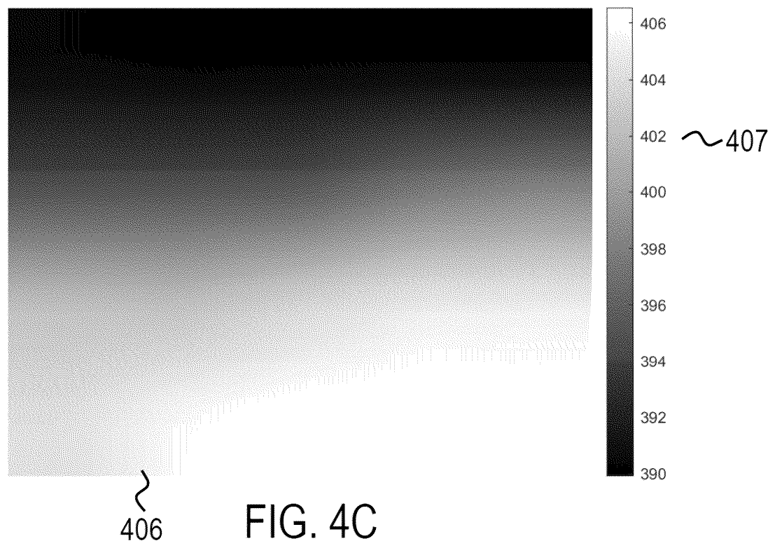

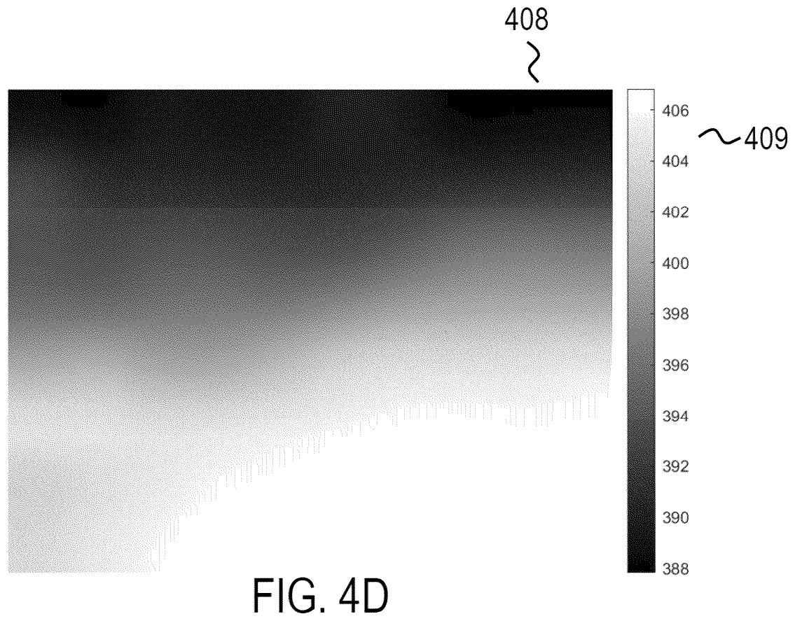

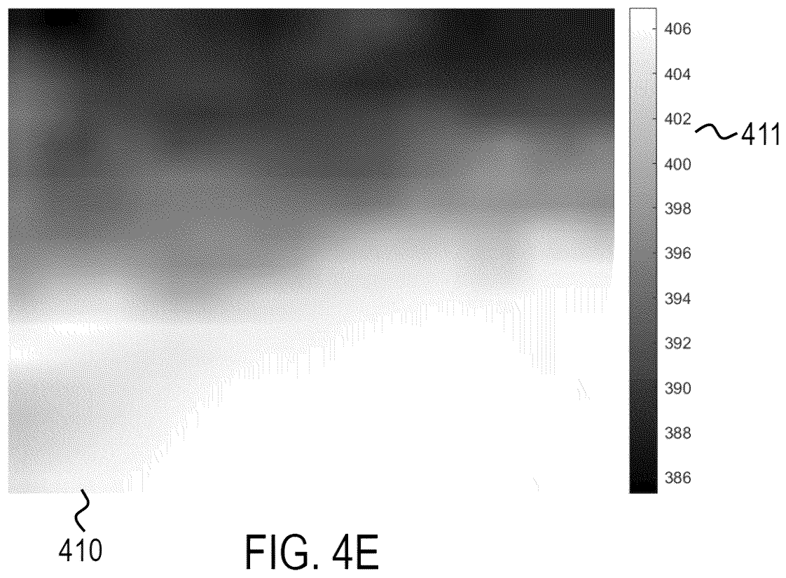

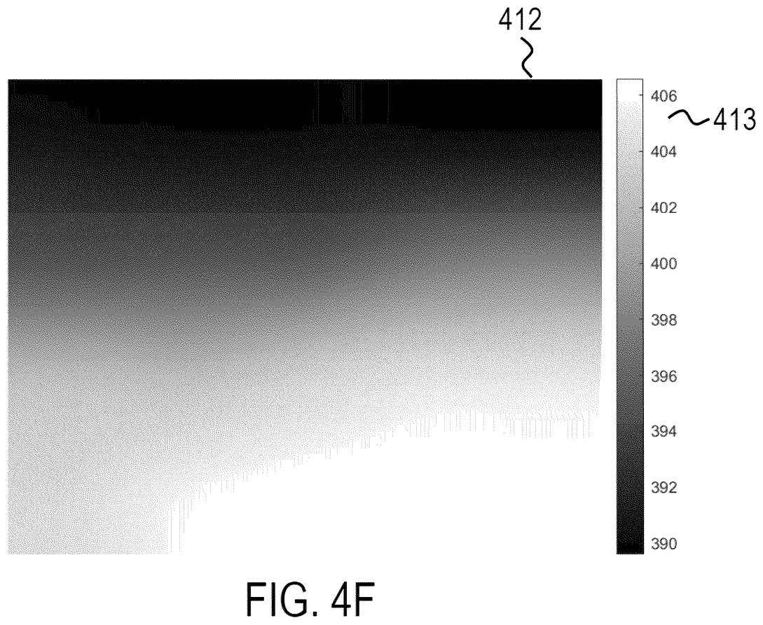

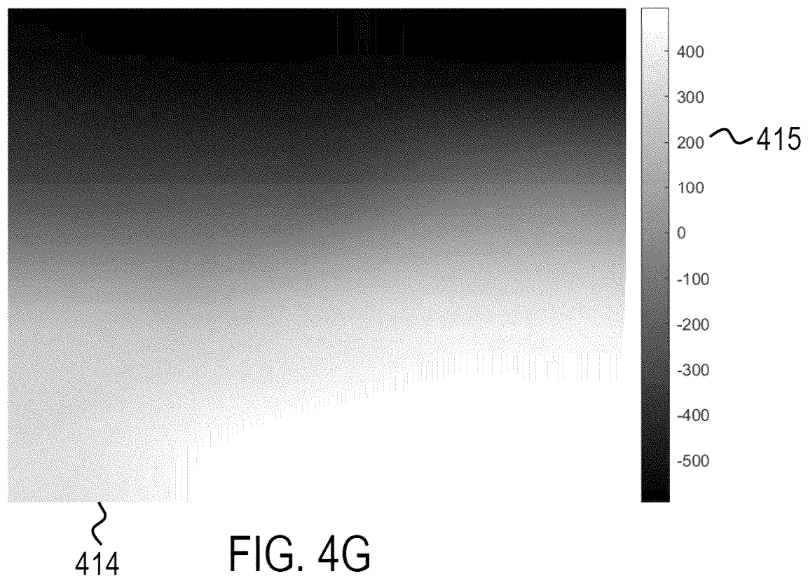

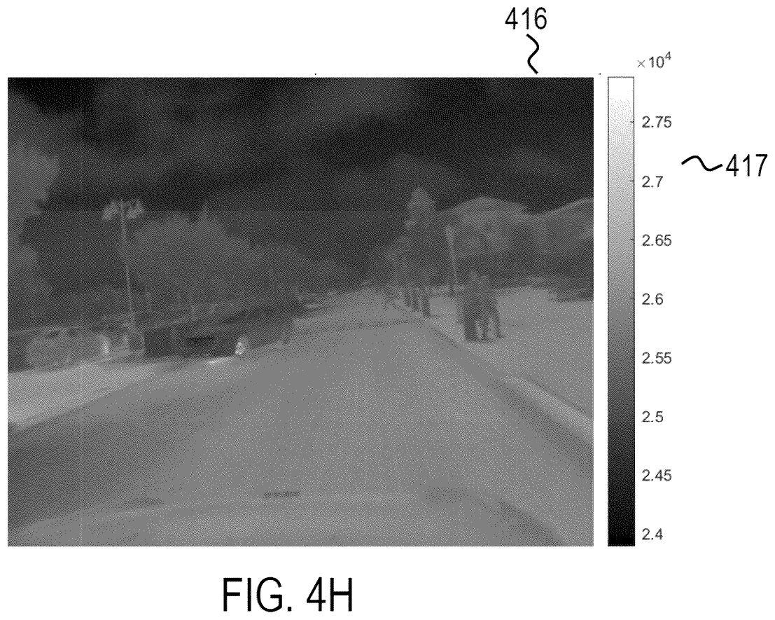

FIGS. 4A-4H illustrate another example of the various changes to the original thermal image through the process described in FIG. 2 in accordance with embodiments of the disclosure. FIG. 4A illustrates one example of thermal image 402 at an original resolution, the original pixel resolution varying between 2.35×10⁴ to 2.8×10⁴ as shown in scale 403. FIG. 4B illustrates one example of original resolution image 404 with both pixel values in a first range that are greater than or equal to the intermediate pixel value adjusted down (compressed) and pixel values in a second range that are less than the intermediate pixel value adjusted up (expanded). As can be seen in FIG. 4B, the toned range is a combined dynamic range of the compressed pixel values and the expanded pixel values that varies between 385 and 415 as shown in scale 405. FIG. 4C illustrates one example of a downscaled 4 pixels by 5 pixels image 406 with a resolution pixel value varying from 390 to 406 as shown in scale 407, FIG. 3D illustrates one example of a downscaled 8 pixels by 10 pixels image 408 with a resolution pixel value varying from 388 to 407 as shown in scale 409, and FIG. 4E illustrates one example of a downscaled 16 pixels by 20 pixels image 410 with a resolution pixel value varying from 386 to 407 as shown in scale 411. FIG. 4F illustrates one example of a weighted sum image 412 with a resolution pixel value varying from 390 to 407 as shown in scale 413. FIG. 4G illustrates one example of a shading image 414 with a resolution pixel value varying from −600 to 500 as shown in scale 415. FIG. 4H illustrates one example of a shading corrected image 416. As can be seen in FIG. 4H the resolution pixel value has changed to vary between 2.4×10⁴ and 2.8×10⁴ as shown in scale 417.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice versa.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

The foregoing description is not intended to limit the present disclosure to the precise forms or particular fields of use disclosed. Embodiments described above illustrate but do not limit the invention. It is contemplated that various alternate embodiments and/or modifications to the present invention, whether explicitly described or implied herein, are possible in light of the disclosure. Accordingly, the scope of the invention is defined only by the following claims.

What is claimed is:

1. A method comprising:
receiving a captured thermal image having an original resolution, wherein the captured thermal image comprises scene information and shading information;
processing the captured thermal image to generate a plurality of downscaled images each having an associated reduced resolution lower than the original resolution and different from each other, wherein the downscaled images exhibit reduced scene information in relation to the captured thermal image;
generating a shading image using the downscaled images; and
adjusting the captured thermal image using the shading image to generate a processed thermal image with reduced shading information in relation to the captured thermal image.

2. The method of claim 1, wherein the adjusting the captured thermal image comprises subtracting the shading image from the captured thermal image.

3. The method of claim 1, wherein the generating comprises upscaling the downscaled images to the original resolution to provide upscaled images.

4. The method of claim 3, wherein the generating the shading image comprises:
weighting the upscaled images to generate weighted upscaled images;
combining the weighted upscaled images to generate a combined weighted upscaled image; and
removing a mean value from the combined weighted upscaled image.

5. The method of claim 1, wherein the original resolution is a multiple of the reduced resolutions.

6. The method of claim 1, wherein the plurality of downscaled images comprises a first downscaled image having a first reduced resolution, a second downscaled image having a second reduced resolution, and a third downscaled image having a third reduced resolution, wherein the first, second, and third reduced resolutions are less than the original resolution and are different from each other.

7. The method of claim 1, wherein the captured thermal image comprises a plurality of pixels having associated pixel values distributed over an original dynamic range, the method further comprising adjusting the pixel values to exhibit a reduced dynamic range before the processing.

8. The method of claim 7, wherein the adjusting the pixel values comprises:
selecting an intermediate one of the pixel values;
compressing the pixel values greater than the intermediate pixel value toward the intermediate pixel value;
expanding the pixel values less than the intermediate pixel value toward the intermediate pixel value; and
wherein the reduced dynamic range is a combined dynamic range of the compressed pixel values and the expanded pixel values.

9. The method of claim 8, wherein the intermediate pixel value is between a mean of the pixel values and a maximum of the pixel values.

10. The method of claim 7, wherein the reduced dynamic range causes the downscaled images to exhibit increased shading information and the processed thermal image to exhibit further reduced shading information.

11. A system comprising:
a memory component storing machine-executable instructions; and
a logic device configured to execute the instructions to cause the system to:
receive a captured thermal image having an original resolution, wherein the captured thermal image comprises scene information and shading information,
process the captured thermal image to generate a plurality of downscaled images each having an associated reduced resolution lower than the original resolution and different from each other, wherein the downscaled images exhibit reduced scene information in relation to the captured thermal image,
generate a shading image using the downscaled images, and
adjust the captured thermal image using the shading image to generate a processed thermal image with reduced shading information in relation to the captured thermal image.

12. The system of claim 11, wherein the adjusting the captured thermal image comprises subtracting the shading image from the captured thermal image.

13. The system of claim 11, wherein the logic device is further configured to execute the instructions to cause the system to upscale the downscaled images to the original resolution to provide upscaled images.

14. The system of claim 13, wherein the logic device is further configured to execute the instructions to generate the shading image by:
weighting the upscaled images to generate weighted upscaled images;
combining the weighted upscaled images to generate a combined weighted upscaled image; and
removing a mean value from the combined weighted upscaled image.

15. The system of claim 11, wherein the original resolution is a multiple of the reduced resolutions.

16. The system of claim 11, wherein the plurality of downscaled images comprises a first downscaled image having a first reduced resolution, a second downscaled image having a second reduced resolution, and a third downscaled image having a third reduced resolution, wherein the first, second, and third reduced resolutions are less than the original resolution and are different from each other.

17. The system of claim 11, wherein the captured thermal image comprises a plurality of pixels having associated pixel values distributed over an original dynamic range, wherein the logic device is further configured to execute the instructions to adjust the pixel values to exhibit a reduced dynamic range before the processing.

18. The system of claim 17, wherein the logic device is further configured to execute the instructions to adjust the pixel values by:
selecting an intermediate one of the pixel values;
compressing the pixel values greater than the intermediate pixel value toward the intermediate pixel value;
expanding the pixel values less than the intermediate pixel value toward the intermediate pixel value; and
wherein the reduced dynamic range is a combined dynamic range of the compressed pixel values and the expanded pixel values.

19. The system of claim 18, wherein the intermediate pixel value is between a mean of the pixel values and a maximum of the pixel values.

20. The system of claim 17. wherein the reduced dynamic range causes the downscaled images to exhibit increased shading information and the processed thermal image to exhibit further reduced shading information.
